(19) United States
(12) Patent Application Publication
(10) Pub. No.: US 2001/0029541 A1
(43) Pub. Date: Oct. 11, 2001

(54) Equipment management system and method

(76) Inventor: Atsushi Tomita, Toyohashi-shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/818,660

(22) Filed: Mar. 28, 2001

(30) Foreign Application Priority Data
Mar. 28, 2000 (JP) 2000-88269

(51) Int. Cl. G06F 15/16

(52) U.S. Cl. 709/230

(57) ABSTRACT

A management center computer transmits to Internet in advance an E-mail containing connection check data addressed to a data terminal newly installed. Then, the data terminal newly installed receives the E-mail containing the connection check data addressed to the terminal itself after the installation work has completed and before starting management of the copying machine. Upon receipt of this E-mail, connection check of the newly installed data terminal is made.

This application is based on Application No. 2000-88269 filed in Japan, contents of which is hereby incorporated by reference.

### BACKGROUND OF THE INVENTION

1. Field of the Invention

The present invention relates to equipment management system and method for managing equipment.

More particularly, the present invention relates to equipment management system and method capable of speedily making a connection check when equipment management apparatus for integrally managing equipment is newly installed.

2. Description of Related Art

Conventionally, it has been well known that an equipment management system transmits equipment management information acquired by an equipment management apparatus to a central management center via a communication line, and the central management center centrally manages a plurality of equipment. In such an equipment management system, in the case where an equipment management apparatus for integrally managing a plurality of equipment is newly installed, it is first checked whether or not connection between the newly installed equipment management apparatus and the central management center is properly made.

In an equipment management system utilizing a public telephone circuit (real time communication means) which has been widely employed conventionally, in general, an equipment management apparatus transmits connection check data for making connection check to a central management center, whereby connection check is made. Namely, when a newly installed equipment management apparatus is activated, whereby connection check data can be normally transmitted to the central management center, it is possible to check that the equipment management apparatus is normally connected to the central management center. Thus, the reason why the equipment management apparatus transmits connection check data is that the equipment management apparatus is often connected to a telephone identical to that of another communication terminal such as facsimile machine, and does not have a specific telephone number.

In recent years, with diversified communication technology, there has been also developed an equipment management system for transmitting and receiving data between an equipment management system and a central management center by utilizing communication means for transferring packet data such as Internet. Such communication means has rapidly become popular because of its high efficiency, i.e., because it can share a line without occupying a line until data transmission has completed, unlike a public telephone circuit.

However, in the case where data is transmitted and received between an equipment management apparatus and a central management center by communication means for transferring packet data such as Internet, transmission data is transferred to a plurality of data processors (computers), and is delivered to a transmission destination. Thus, when a new equipment management apparatus is installed, if the equipment management apparatus transmits connection check data to the central management center, it is not determined when the central management center has received such connection check data. In addition, even if the central management center responds to the equipment management apparatus the fact the center has received connection check data, it is not determined when the equipment management apparatus receives such response.

Thus, there is apprehension that a very long time is required for terminating connection check. In such a case, there has been a problem that dispatched service engineer must work at a site to which they are dispatched for a long time in order to make connection check of a newly installed equipment management apparatus or a service engineer must be dispatched many times for the purpose of connection check only.

### SUMMARY OF THE INVENTION

The present invention has been made in order to solve the foregoing problem. It is an object of the present invention to provide an equipment management system and method capable of speedily making connection check when an equipment management apparatus for integrally managing equipment is newly installed.

According to the present invention, there is provided an equipment management system for managing equipment by an equipment management apparatus for acquiring management information from equipment and a central management apparatus for centrally managing management information making packet data communication via a network over which a data processor is connected, the central management apparatus comprising:

a transmission controller for transmitting the data processor in advance packet data containing connection check data addressed to a newly installed equipment management apparatus,

the equipment management apparatus comprising:

a reception controller for acquiring from the data processor the packet data containing connection check data transmitted to the apparatus before starting the equipment management.

In this equipment management system, management information from equipment is acquired by the equipment management apparatus. Namely, a variety of signals originated from each equipment (for example, a signal concerning a use state of expendables or troubles or the like) are received by the equipment management apparatus. In addition, packet data communication via a network over which a data processor is connected can be made between the equipment management apparatus and the central management apparatus. Further, equipment is managed based on communication between the equipment management apparatus and the central management apparatus.

In the case where a new equipment management apparatus is installed, it is required to check that data is normally transmitted and received between the new equipment management apparatus and the central management apparatus. The installation of this new equipment management apparatus includes replacement of a conventionally installed equipment management apparatus with the replacement apparatus.

In this equipment management system, at the central management apparatus, there is provided a transmission controller for transmitting to the data processor the packet data containing connection check data addressed to a newly installed equipment management apparatus. In addition, at the equipment management apparatus, there is provided a reception controller for acquiring from the data processor the packet data containing connection check data addressed to the apparatus before starting equipment management. Thus, the packet data containing connection check data is transmitted to the data processor by means of the transmission controller. Then, the connection check data is transmitted from the data processor to the equipment management apparatus. The reception controller receives the data. The packet data containing connection check data is transmitted from the transmission controller before installing the equipment management apparatus. This is because the reception controller provided at the equipment management apparatus can acquire connection check data immediately after the new equipment management apparatus has been installed.

In the case where connection check data is normally acquired by means of the reception controller, it means that the newly installed equipment management apparatus and the central management apparatus are normally connected to each other, that is, data communication is normally made. Therefore, service engineer only makes reception check of connection check data by using the equipment management apparatus, which is a connection check after the equipment management apparatus has been newly installed. In this manner, the service engineer can make connection check speedily. Thus, there is no need for the service engineer to work for a long time at a site to which they are dispatched for the purpose of connection check. In addition, there is no need for a service engineer to be dispatched many times for the purpose of connection check.

According to the present invention, there is provided an equipment management method for managing equipment by an equipment management apparatus for acquiring management information from equipment and a central management apparatus for centrally managing management information making packet data communication via a network over which a data processor is connected, comprising the step of:

a step at which the central management apparatus transmits the data processor in advance packet data containing connection check data addressed to a newly installed equipment management apparatus;

a step at which the equipment management apparatus acquires from the data processor the packet data containing connection check data transmitted to the apparatus before starting equipment management; and

a step at which equipment management starts after the equipment management apparatus normally acquires connection check data.

By such an equipment management method as well, as in the above equipment management system, connection check can be made speedily when an equipment management apparatus is newly installed. Thus, there is no need for a service engineer to work at a site to which they are dispatched for a long time for the purpose of connection check. In addition, there is no need for the service engineer to be dispatched many times for the purpose of connection check.

According to another aspect of the present invention, there is provided an equipment management method for managing an equipment by an equipment management apparatus for acquiring management information from equipment and a central management apparatus for centrally managing management information making communication in accordance with a first communication system or a second communication system, the equipment management method comprising the steps of:

registering information concerning an equipment management apparatus to be newly installed at the central management apparatus;

determining whether a communication system between the newly installed equipment management apparatus and the central management apparatus is a first communication system or a second communication system; and

in the case where the communication system is the first communication system, the central management apparatus transmitting connection check data addressed to the equipment management apparatus without receiving initial transmission data from the equipment management apparatus to be newly installed, and in the case where the communication system is the second communication system, the central management apparatus transmitting the connection check data addressed to the equipment management apparatus in response to reception of the initial transmission data from the equipment management apparatus to be newly installed.

In this equipment management method, it is first determined whether the communication system between the newly installed equipment management apparatus and the central management apparatus is the first communication system or the second communication system. Here, the first communication system can include s packet data communication system utilizing Internet, for example. The second communication system can include a communication system utilizing a public telephone circuit network, for example.

In the case where the communication system between the newly installed equipment management apparatus and the central management apparatus is the first communication system, the central management apparatus transmits connection check data addressed to the equipment management apparatus without receiving initial transmission data from the newly installed equipment management apparatus. In a non-real time communication system such as packet data communication utilizing Internet, connection check data addressed to the newly installed equipment management apparatus can be transmitted in advance. When an installation work of the equipment management apparatus terminates, the equipment management apparatus checks whether or not the apparatus can receive connection check data addressed to the apparatus, whereby connection check can be made. That is, at this time, if the newly installed equipment management apparatus normally receives connection check data, it means that the equipment management apparatus and the management apparatus are normally connected to each other, i.e., data communication can be made.

On the other hand, in the case where it is determined that the communication system between the newly installed equipment management apparatus and the central management apparatus is the second communication system, the central management apparatus transmits connection check data addressed to the equipment management apparatus in response to reception of initial transmission data from the newly installed equipment management apparatus. In a real time communication system such as communication utilizing a public telephone circuit network, the connection check data addressed to the newly installed equipment management apparatus cannot be transmitted in advance. Thus, the connection check data is transmitted in accordance with the above described method. When the newly installed equipment management apparatus can receive the connection check data, it means that the equipment management apparatus and the central management apparatus are normally connected to each other, that is, data communication can be normally made.

In this manner, this equipment management method determines type of communication method between the newly installed equipment management apparatus and the central management apparatus. According to the determination result, the above method changes a method for originating connection check data for the purpose of initial setting check in accordance with a respective one of the communication systems. Therefore, the connection check method in accordance with the communication system is employed so that the service engineer can check the newly installed equipment management apparatus and the central management apparatus for normal connection speedily. In this way, there is no need for the service engineer to work at a site to which they are dispatched for a long time for the purpose of connection check after the installation work has completed. In addition, there is no need for the service engineer to be dispatched many times for the purpose of connection check.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principle of the present invention.

FIG. 1 is a schematic view showing a copying machine management system according to a first embodiment;

FIG. 2 is a block diagram depicting a computer configuration;

FIG. 3 is a block diagram depicting a configuration of a copying machine and a data terminal;

FIG. 4 is a diagram illustrating a configuration of packet data transmitted and received between the data terminal and the computer;

FIG. 5 is a diagram illustrating a configuration of data input to the data terminal;

FIG. 6 is a flow chart illustrating an operation of a CPU in the copying machine;

FIG. 7 is a flow chart illustrating an operation of a CPU in the data terminal.

FIG. 8 is a flow chart illustrating a control operation of E-mail transmission and reception processing in the data terminal;

FIG. 9 is a flow chart illustrating an operation of a CPU in the computer;

FIG. 10 is a flow chart illustrating a control operation concerning E-mail transmission and reception processing;

FIG. 11 is a schematic view showing a copying machine management system according to a second embodiment; and

FIG. 12 is a flow chart illustrating an operation of a CPU in the computer.

### DETAILED DESCRIPTION OF THE PREFERRED EMBODIMENTS

Reference will now be made in detail to the presently preferred embodiments of the invention as illustrated in the accompanying drawings, in which like reference numerals designate like or corresponding parts.

Hereinafter, preferred embodiments invention embodying an equipment management system and method of the present invention will be described with reference to the accompanying drawings. The present embodiments of the present invention are application of the present invention to central management of an image forming apparatus. Although a specific example of a copying machine is shown as this image forming apparatus, it may be a printer or a facsimile machine. In addition, as a plurality of equipment to be managed, there are assumed a variety of devices such as business machines such as image scanner or personal computer or home electronics product having communication facilities other than image forming apparatus.

(First Embodiment)

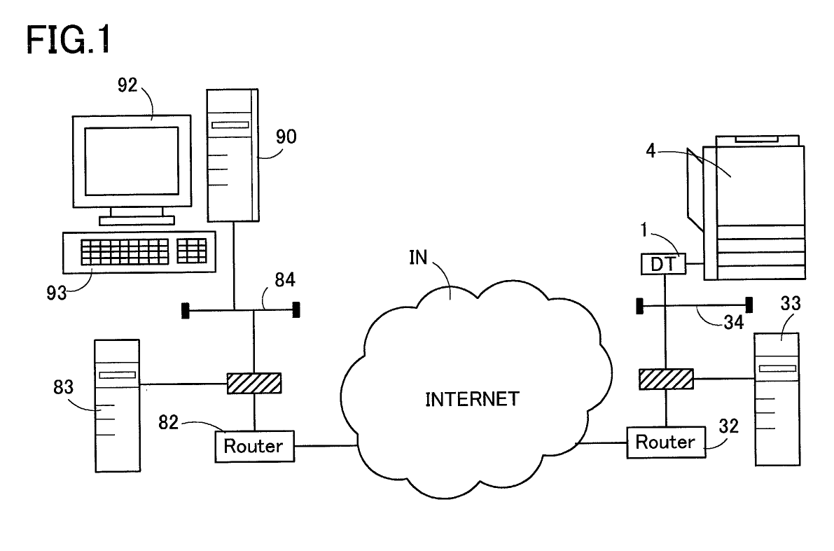

Now, a first embodiment will be described here. As shown in FIG. 1, a copying machine management system according to the first embodiment is composed essentially of: a copying machine 4 installed at a user site; a data terminal 1 (equipment management apparatus); a computer 90 installed at a central management center site; and Internet IN that is data communication means between the data terminal 1 and the computer 90.

The data terminal 1 is connected to a LAN 34 installed at the user site. In the present embodiment, although only one data terminal is connected to the LAN 34, of course, a number of data terminals can be connected. The data terminal 1 is connected to Internet IN via a router 32 through the LAN 34. In addition, a mail server 33 for E-mail transmission and reception is connected to the LAN 34. A firewall for preventing illegal access is provided between the router 32 and the LAN 34.

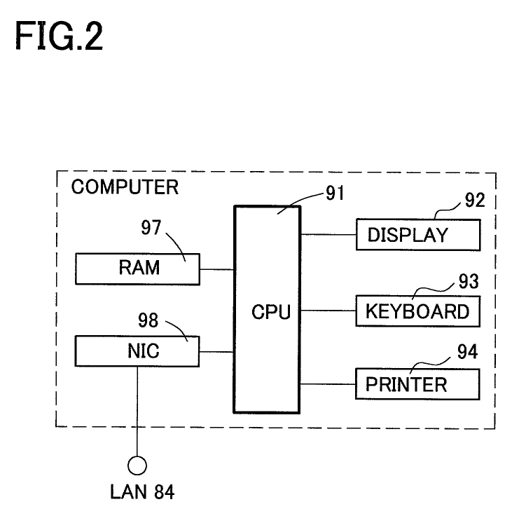

In addition, as shown in FIG. 2, a CPU 91 is mounted on the computer 90, and a display 92, a keyboard 93, a printer 94 and a RAM 97 are connected to the computer 90. This computer 90 is connected via an NIC 98 to a LAN 84 installed at the management center site. As shown in FIG. 1, the computer 90 is connected to Internet IN via the router 82 through the LAN 84. In addition, a mail server 83 for E-mail transmission and reception is connected to the LAN 84. A firewall for preventing illegal access is provided between the router 82 and the LAN 84. Here, a central management apparatus of the management center is composed of the computer 90, display 92, and keyboard 93. The central management apparatus may include another device such as printer.

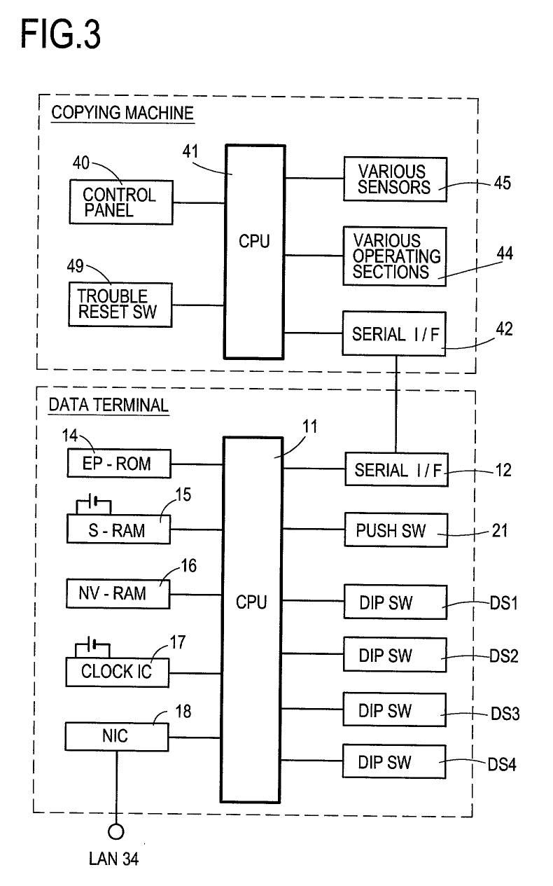

The copying machine 4 used here reproduces a document image on paper. On this copying machine 4, a CPU 41 is mounted as shown in FIG. 3. To the CPU 41, there are connected an control panel 40, various sensors 45, various operating sections 44, a serial I/F 42 and a trouble reset switch 49 or the like. At the CPU 41, there is counted each of the count values of a counter that is a base of an amount of money for charging copy payment computed by the computer 90 at the management center (total counter indicating paper ejection count or paper size based counter indicating use count by paper size); and a counter for determining necessity of maintenance (JAM counter indicating JAM occurrence count, trouble counter indicating trouble occurrence count, or PM counter for counting use count by parts mounted on the copying machine). Each of the count values after counted is transmitted to a CPU 11 at the data terminal 1 via a serial I/F 42 and a serial I/F 12.

In addition, a variety of element data that influences an image forming process (for example, data concerning required time for carrying paper; surface potential of photosensitive drum; toner density in developer; exposure to photosensitive drum; development bias potential, quantity of toner deposited to photosensitive drum and grid potential of electrification charger) are detected by means of a variety of sensors 45 arranged at sites in the copying machine 4. The detected values are acquired and processed by the CPU 41 so as to be transmitted to the CPU 11 of the data terminal 1 via the serial I/F 42 and the serial I/F 12.

On the other hand, the data terminal 1 acquires various items of information on the copying machine 4, and applies predetermined processing to the acquired various items of information. Then, the data terminal 1 transmits the processed various items of information to the computer 90 at the management center. On this data terminal 1, the CPU 11 is mounted as shown in FIG. 3. To the CPU 11, there are connected a serial I/F 12, an EP-ROM 14, an SRAM 15, an NVRAM 16, a clock IC 17, a network interface card (hereinafter, referred to as NIC) 18, a push switch 21, DIP switches DS 1 to DS 4 or the like.

The data terminal 1 identifies the copying machine 4 in accordance with a port number of the serial I/F 12. The data terminal 1 and the copying machine 4 can be connected to each other via an I/F other than serial I/F.

A control program of the data terminal 1 is stored in the EP-ROM 14 so that an E-mail address or the like of the computer 90 at the management center is stored in the NVRAM 16. In addition, the SRAM 15 and clock IC 17 each are battery backed up. Various items of management information acquired from the copying machine 4 is stored in the SRAM 15. The NIC 18 has a function for transmitting and receiving an E-mail via Internet IN.

The push switch 21 is a switch for transmitting various items of counter information or element information on the copying machine 4 through user operation. In addition, the DIP switch DS 1 is a switch for setting an E-mail address input mode of the computer 90 installed at the management center; a DIP switch DS 2 is a switch setting a mode for inputting an ID number identifying the data terminal 1; DIP switch DS 3 is a switch for setting a mode for inputting an ID number identifying the management center; and a DIP switch DS 4 is a switch for setting an initial setting mode.

The CPU 11 can issue an instructive command to the NIC 18 so as to transmit packet data containing an E-mail (hereinafter, simply referred to as E-mail) to the computer 90 In this way, the CPU 11 is connected to Internet IN via the router 32 so that an E-mail can be transmitted to the computer 90.

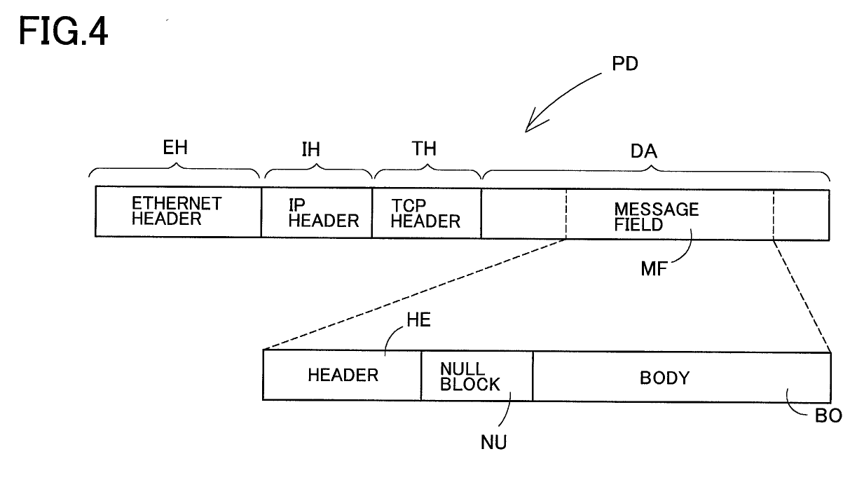

The packet data PD (E-mail) transmitted and received between the data terminal 1 and the computer 90 is composed of: Ethernet (registered trademark) header EH; an IP (Internet Protocol) header IH; a TCP (Transmission Control Protocol) header TH; and a data portion DA, as shown in FIG. 4. The Ethernet (registered trademark) header EH includes a destination hardware address, a transmission source hardware address or the like. The IP header IH includes a transmission source IP address, a destination IP address or the like. The TCP header TH includes a transmission source port number, a destination port number or the like.

The data portion DA includes a message field MF. This message field MF is composed of a header HE, a body BO and a null block NU (blank portion). The header HE includes a destination E-mail address and a transmission source E-mail address. The null block NU is a blank portion to be automatically set in order to delimit between the header HE and the body BO. Data can be freely written into the body BO, and E-mail text data is written herein. For packet data transmitted from the data terminal 1 to the computer 90, various types of data or the like received from the copying machine 4 is written into this E-mail text. In the case of packet data transmitted from the computer 90 to the data terminal 1, an instructive command transmitted to the copying machine 4 or the like is written into the body BO.

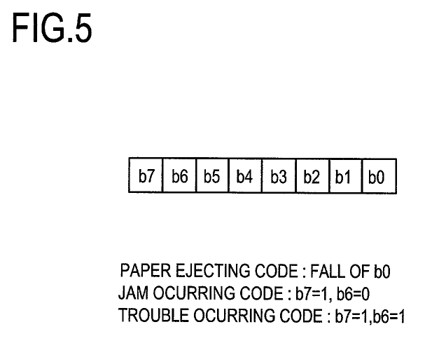

FIG. 5 shows 8-bit data input from the copying machine 4 to the data terminal 1 via the serial I/F 12. As shown in FIG. 5, bit b0 represents a paper ejecting code indicating paper ejection. Bits b7 and b6 represent a JAM occurring code indicating an occurrence of a paper jam and a trouble occurring code indicating an occurrence of various troubles. Specifically, paper ejection is represented by a falling edge (a change from 1 to 0) of bit b0. In addition the JAM occurring code is represented by bit b7=1 and bit b6=0. Further, the trouble occurring code is represented by bit b7=1 and bit b6=1. This 8-bit data is inputted to the data terminal 1 in the case where a paper jam or any other trouble occurs at the copying machine 4. In addition, management data is periodically inputted from the copying machine 4 to the data terminal 1. This management data includes the above described various count values or detected various element data.

With thus configured system, at the management center, various diagnoses relevant to the copying machine 4 (state of copying machine, cause of fault, troubleshooting or the like) are performed based on an E-mail transmitted from the data terminal 1. Based on the diagnoses result, an administrator takes appropriate countermeasures.

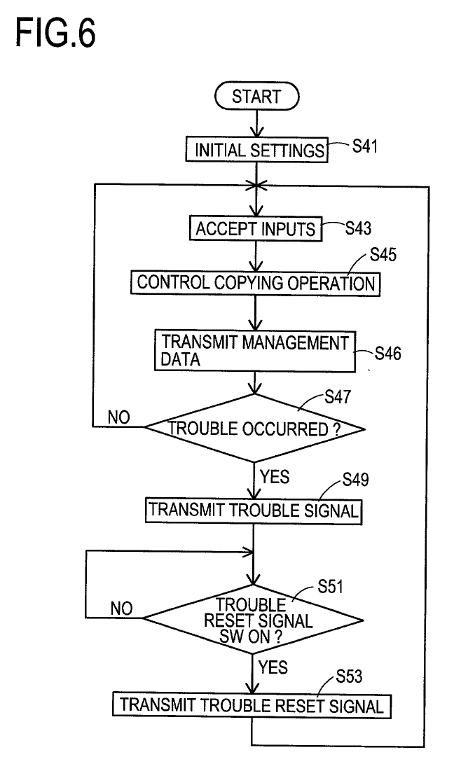

Now, an operation of a copying machine management system having the above configuration will be described here. First, an operation of a CPU 41 in a copying machine 4 will be described with reference to a flow chart shown in FIG. 6. When the copying machine 4 is powered ON, initial settings such as memory clearing or standard mode setting are performed (S41). Next, an input from an control panel 40 and inputs from various sensors 45 or an input from a data terminal 1 are accepted (S43). Specifically, the former inputs include various element data and various count values or the like. And the latter inputs include a setting condition change command of the copying machine 4 or an operation request command and the like.

There are executed copy controls, namely, such controls as of various operating sections 44 such as paper feeding control, photosensitive drum control or developer control and the like or setting change or operation or the like based on an instructive command input from the data terminal 1, and a document copy is made (S45). Then, management data is transmitted to the data terminal 1 (S46). This management data includes the above described various counter values or various types of element data. In general, this management data transmission is automatically originated at a predetermined period.

Subsequently, it is determined whether or not there occurs a trouble such as paper carrying failure (JAM) or control or operation failure of each operating portion (S47). In the case where no trouble occurs (S47: NO), processing reverts to S43. In the case where a trouble occurs (S47: YES), a signal corresponding to the trouble that occurs is transmitted to the CPU 11 of the data terminal 1 (S49). Thus transmitted trouble signal is in accordance with above mentioned a data format signal shown in FIG. 3. Further, it is determined whether or not a trouble reset switch 49 is turned ON by an operator or the like (S51). When it is determined that the trouble reset switch 49 is turned ON (S51: YES), a trouble reset signal is transmitted to the CPU 11 of the data terminal 1 (S53). Then, processing reverts to S43.

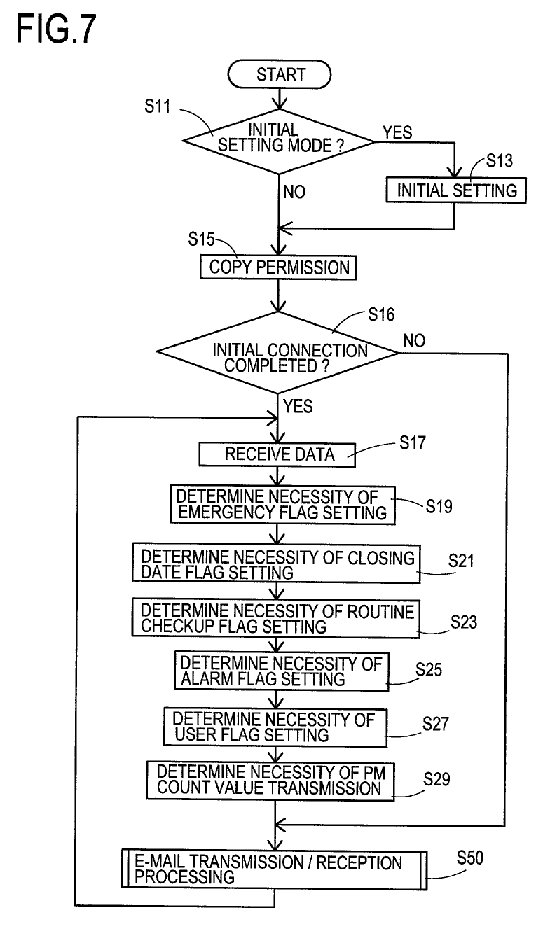

Now, control processing in the CPU 11 mounted on the data terminal 1 will be described here with reference to a flow chart shown in FIG. 7. When the data terminal 1 is powered ON, it is determined whether or not initial setting mode is established (S11). In the case where the initial setting mode is established, specifically in the case where the DIP switch DS 4 is turned ON (S11: YES), initial setting procedures are performed (S13). Then, a copy permission signal is transmitted to the CPU 41 of the copying machine 4 (S15). In the initial setting process, there is performed processing such as setting an ID number of the data terminal 1 and an ID number of computer 90. On the other hand, in the case where the initial setting mode is not established (S11: NO), the copy permission signal is transmitted to the CPU 41 of the copying machine 4 immediately (S15).

When the copy permission signal is transmitted, it is checked whether or not initial connection between the data terminal 1 and the computer 90 has completed (S16). As described later, in the case where the data terminal 1 receives an E-mail including initial connection check data transmitted in advance from the computer 90 of the management center, the completion of initial connection is determined. In the case where initial connection completes (S16: YES), there are sequentially executed data reception processing (S17), emergency flag setting determination processing (S19), closing date flag setting determination processing (S21), routine checkup flag setting determination processing (S23), alarm flag setting determination processing (S25), user flag setting determination processing (S27), PM count value determination processing (S29), E-mail transmission and reception processing (S50). On the other hand, in the case where initial connection is not completed (S16: NO), E-mail transmission and reception processing (S50) is executed immediately.

At this time, during E-mail transmission and reception processing, an E-mail addressed to the E-mail address of the own data terminal 1 is acquired immediately. This E-mail includes initial connection check data and E-mail address of the computer 90. The E-mail is transmitted in advance from the computer 90 of the management center to an E-mail server 33 before making initial connection of the data terminal. E-mail transmission and reception processing will be described later in more detail.

The data reception processing (S17) used here denotes processing for receiving various types of management data concerning a state of the copying machine 4, the management data being periodically transmitted. The data received during this processing includes a paper ejecting code, a JAM trouble code, JAM trouble count value; paper size based count value, a PM count value and a variety of element data values or the like. These items of update data is stored in the SRAM 15 of the data terminal 1. Then, the update data stored in the SRAM 15 is transmitted to the computer 90 of the management center periodically or whenever necessary. In addition, during data reception processing, if a trouble occurs with the copying machine 4, a trouble signal transmitted from the copying machine 4 is received.

In addition, emergency flag setting determination processing (S19) denotes processing for determining whether or not the trouble data or trouble recovery data on the copying machine 4 is transmitted to the computer 90 of the management center. If a trouble occurs with the copying machine 4, a trouble flag is turned on. When the trouble flag is turned on, the flag is determined during E-mail transmission and reception processing at S50. Then, an E-mail including trouble data is transmitted to the computer 90 of the management center.

Closing date flag setting determination processing (S21) denotes processing for determining necessity of signal transmission to the computer 90 of the management center concerning a total count value that is a base of computation of an amount of money for charging copy payment and paper size based count value at a predetermined closing date. Data concerning closing time and date transmitted from the management center is stored in the SRAM 15. When the closing date has come, a closing date flag is turned on. When the closing date flag is turned on, the flag is determined during E-mail transmission and reception processing at S50. Then, an E-mail including management data on the copying machine 4 is transmitted to the computer 90 of the management center. After the transmission has completed, the computer 90 of the management center transmits data concerning next closing time and date by return.

Routine checkup flag setting determination processing (S23) denotes processing for determining necessity of signal transmitting to the computer 90 of the management center concerning various types of data such as a state of the copying machine 4 at a predetermined transmission time. Routine checkup time data of the copying machine 4 transmitted from the management center is stored in the SRAM 15. When the flag setting time has come, a routine checkup flag is turned on. When the routine checkup flag is turned on, the flag is determined during E-mail transmission and reception processing at S50. Then, an E-mail including management data on the copying machine 4 is transmitted to the computer 90 of the management center. After the transmission has completed, the computer 90 of the management center transmits current time data and data concerning next routine checkup time and date by return.

The alarm flag setting determination processing (S25) denotes processing in which element data, a count value of a JAM counter and a count value of a PM counter are compared respectively with predetermined thresholds so as to determine whether or not alarm data or alarm cancellation data is transmitted to the computer 90 of the management center based on the comparison result. The thresholds are stored in the SRAM 15. When the count value or element data of the copying machine 4 exceeds the thresholds, an alarm flag is turned on. When the alarm origination flag is turned on, the flag is determined during E-mail transmission and reception processing at S50. Then, an E-mail including management data such as alarm information on the copying machine 4, element data, the count value of the JAM counter and count value of the PM counter or the like is transmitted to the computer 90 of the management center.

Further, the user flag setting determination processing (S27) denotes origination determination processing for, in the case where a push switch 21 is pressed by the user, transmitting various types of data concerning the state of the copying machine 4 to the computer 90 of the management center. The PM count value determination processing (S29) denotes origination determination processing for transmitting to the computer 90 of the management center the count value of the PM counter before being zero-cleared through part replacement.

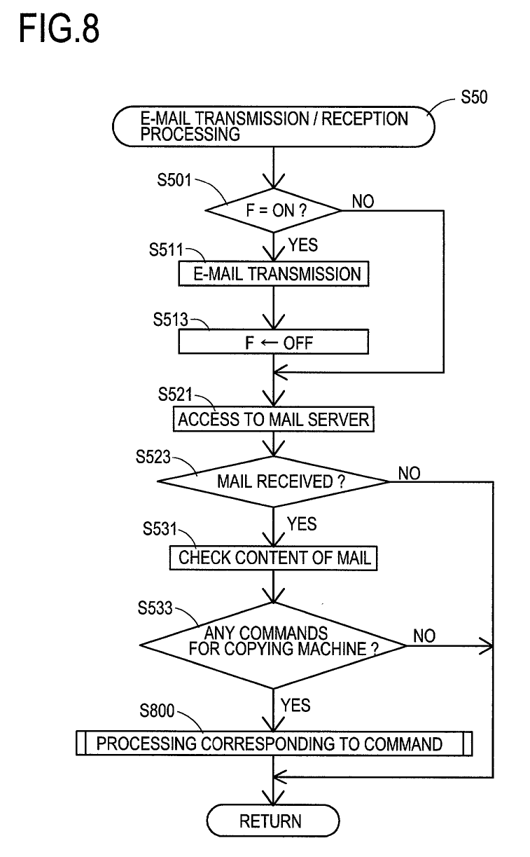

The E-mail transmission and reception processing (S50) denotes processing for E-mail transmission and reception. A description of this processing will be given with reference to a flow chart shown in FIG. 8. First, it is determined by the data terminal 1 whether or not a flag is turned on (S501). The determination of the flag at S501 performs determination of various flags turned on in the above described various determination processes. Specifically, it is determined whether or not various flags such as trouble origination flag, closing date flag, routine checkup flag or alarm flag or the like are turned on.

When any of these flags is turned on (S501: YES), the data corresponding to the signal flag is transmitted to Internet IN as packet data having assigned thereto E-mail address of the computer 90 of the management center (S511). When the data terminal 1 transmits data to Internet IN, the original signal flag that has been turned on is set to OFF (S513). On the other hand, in the case where all the origination signal flags are turned off (S501: NO), processing at S521 is executed immediately.

Subsequently, whether or not an E-mail addressed to the data terminal 1 is delivered is read from the E-mail server 33 (S521). In the case where an E-mail is received (S523: YES), that E-mail is read out from the E-mail server 33, and its contents are checked (S531) Here, the E-mail transmitted from the computer 90 to the data terminal 1 includes: a setting change command for changing setting conditions of the copying machine 4; an operation request command for requesting an operation of the copying machine 4; current time data, data concerning next routine checkup time and date; or data concerning next closing time and date or the like, for example. In addition, the E-mail transmitted in advance from the computer 90 for the purpose of initial connection check includes E-mail address of the computer 90 and initial connection check data. Further, this E-mail includes a display command for displaying initial connection check on the control panel 40 of the copying machine and initial setting data on the data terminal. On the other hand, in the case where no E-mail addressed to the data terminal 1 is delivered (S523: NO), E-mail transmission and reception processing terminates.

Then, it is checked whether or not the E-mail addressed to the data terminal 1 includes an instructive command issued to the copying machine 4 (such as setting change command or operation request command) (S533). In the case where the above E-mail includes the command issued to the copying machine 4 (S533: YES), the data concerning the corresponding command and changed value or the like is transmitted to the CPU 41 of the copying machine 4 via the serial I/F 12 and I/F 42. Then, processing corresponding to the command is executed (S800).

In the case where the above E-mail includes a display command for displaying initial connection check, that display command is transmitted to the CPU 41 of the copying machine. Then, the CPU 41 displays a screen for checking initial connection on the control panel 40 of the copying machine. On this display screen, there are displayed E-mail address of the computer 90, ID of the data terminal 1 (DTID), ID (CTID) of the management center or the like included in the E-mail. A service engineer can check that initial connection has normally completed by checking this display screen. On the other hand, in the case where the E-mail addressed to the data terminal 1 does not include an instructive command issued to the copying machine 4 (S533: NO), E-mail transmission and reception processing terminates.

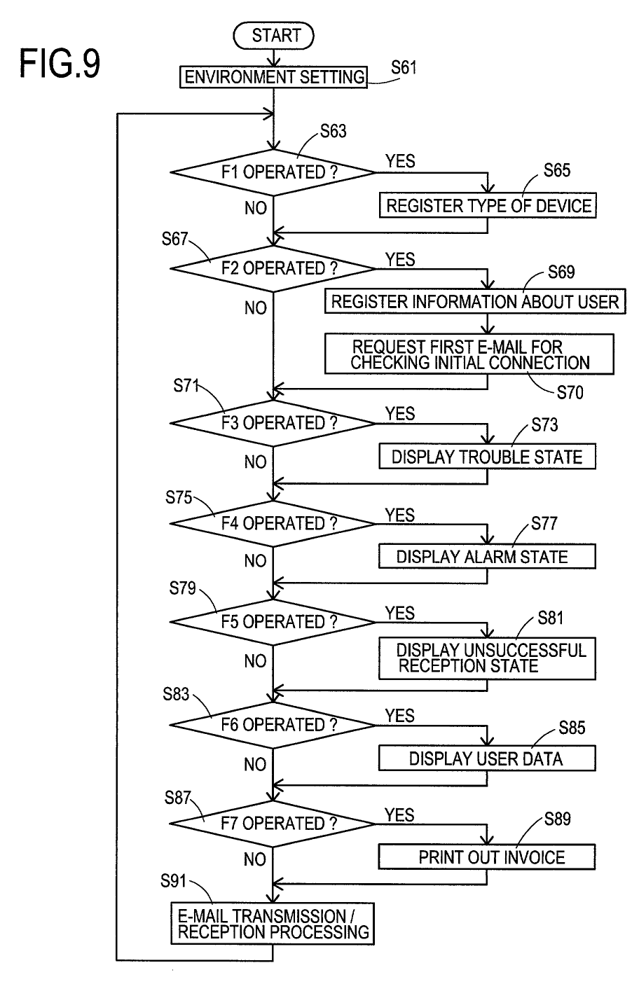

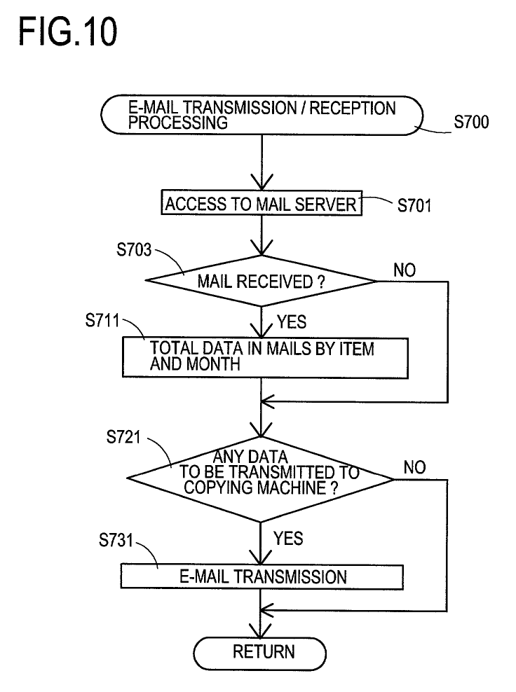

Now, processing of the CPU 91 in the computer 90 of the management center will be described with reference to FIG. 9 and FIG. 10. FIG. 9 is a main flow chart of the CPU 91. The CPU 91 starts processing when it is powered ON, and executes general environment setting (S61). Then, the CPU 91 sets any one of the following modes according to an input operation of keys F1 to F7 on a keyboard 93 or executes the following processing.

When the key F1 is operated (S63: YES), an equipment type registry acceptance mode is set. Then, new registration of equipment type or name, item number of element data, name of element data, standard thresholds of element data or standard thresholds of count data or the like is performed by operation of the keyboard 93 (S65).

When the key F2 is operated (S67: YES), a user master registry acceptance mode is set. Then, new registration of user name, address, telephone number, device type and/or name, device number, or routine checkup time and date or the like is performed by operation of the keyboard 93. When these items of information are registered, ID (DTID) of the data terminal is automatically assigned (S69). When that ID (DTID) is automatically set to a new data terminal, a request for transmitting a first packet (E-mail) is performed for checking initial connection with the data terminal (S70). Upon receipt of this request, during E-mail transmission and reception processing at S91, the computer 90 transmits an E-mail for checking initial connection to the E-mail server 33 at the user site. For this packet first transmitted from the management center, the center own E-mail address and data terminal E-mail address are stored in the packet data header HE as shown in FIG. 4. In addition, the initial connection check data, a display command for displaying initial connection check on the control panel 40 of the copying machine, initial setting data on the data terminal, DTID and CTID or the like are included. As initial setting data relevant to the data terminal, times such as current time, next routine checkup time and date, next closing time and date; element data; and thresholds of a respective one of the JAM counter and PM counter are also stored in the body BO of packet data.

When the key F3 is operated (S71: YES), a trouble state is displayed (S73). That is, user information on a copying machine that had set emergency flag (user name, address, telephone number, device type and/or name), date and time when such trouble occurs and the like are displayed on a display 92 together with the contents of such trouble.

When the key F4 is operated (S75: YES), an alarm state is displayed (S77). That is, user information or the like of the alarmed copying machine is displayed on the display 92 together with the alarm contents.

When the key F5 is operated (S79: YES), an unsuccessful reception state is displayed (S81). That is, user information on a copying machine in which routine checkup has been determined to have been received unsuccessfully is displayed on the display 92.

When the key F6 is operated (S83: YES), a user data display mode is set (S85). That is, user information is displayed on the display 92. At this time, when a sub-menu is selected, the count values of various counts for the user's copying machine (total counter, paper size based counter, JAM counter, trouble counter, and PM counter) and element data are displayed by month or items.

When the key F7 is operated (S87: YES), an invoice is printed out (S89). That is, a printer connected to the computer 90 is activated, and there is printed out an amount of money for charging copy payment computed based on the count value of the total counter and a predetermined algorithm.

Then, at S91, E-mail transmission and reception processing is executed. E-mail transmission and reception processing is executed in accordance with a flow chart shown in FIG. 10. First, whether or not an E-mail addressed to the computer 90 is delivered is read by the E-mail server 93 (S701). In the case where an E-mail is delivered (S703: YES), such E-mail is read out from the E-mail server 93. Based on the contents of the E-mail, data is collected by items or month (S711).

Subsequently, it is checked whether or not data to be transmitted to the copying machine 4 is present, namely, whether or not an E-mail transmission request is made (S721). In the case where data to be transmitted is present (S721: YES), the data is transmitted as an E-mail to the E-mail address of the data terminal 1 controlling the copying machine 4 (S731). Then, E-mail transmission and reception processing terminates. When a request for transmitting a connection check E-mail is made during processing at the previous S70, the above described connection check E-mail is transmitted to the E-mail address of the data terminal 1 at S731. The transmitted E-mail is stored in the E-mail server 33, and is read out during initial connection of the data terminal 1. In addition, even in the case where data to be transmitted is absent (S721: NO), E-mail transmission and reception processing terminates.

In this manner, various types of data or commands are transmitted and received as an E-mail between the data terminal 1 (copying machine 4) and the computer 90 of the management center, whereby the copying machine 4 is managed by the management center. Specifically, based on the data from the copying machine 4, the date and time when a trouble occurs and its contents, alarm state, user information and an amount of money for charging copy payment or the like are managed by the computer 90 of the management center. In some cases, an action of dispatching a service engineer or the like is executed.

In the case where a new data terminal is installed in this system, a service engineer is first dispatched in order to connect the data terminal to the LAN 34 installed at the user site. Then, a new data terminal installation work is performed by a service engineer. On the other hand, at the management center, user information on a copying machine controlled by the data terminal to be newly connected is registered into the computer 90. Specifically, data concerning user name, address, telephone number, device type and/or name, device number, routine checkup time and date or the like is inputted. At this time, an ID number identifying a data terminal to be newly connected to the LAN 34 is automatically set. When this ID number is set, the computer 90 transmits packet data including initial connection check data to Internet IN.

This initial connection check data is packet data that has a structure shown in FIG. 4. The data portion DA includes E-mail address of the computer 90 itself; E-mail address of newly installed data terminal; a display command for displaying initial connection check on the control panel 40 of the copying machine; DTID; CTID; and initial setting data (current time, next routine checkup time and date, next closing time and date, and element data thresholds) or the like.

At a time when a service engineer completes installation work, it is checked whether or not a newly connected data terminal can receive precisely initial connection check data transmitted from the computer 90. When the data is normally received, the fact can be checked by E-mail address of the management center (computer 90) being displayed on the initial connection check screen displayed on the control panel 40 of the copying machine. Through this reception check, a service engineer can complete connection check. In addition, E-mail address of the computer 90 and initial setting data is automatically registered in the data terminal newly connected to the LAN 34.

As has been described above in detail, according to the copying machine management system according to the first embodiment, a service engineer can make connection check merely by making reception check of initial connection check data transmitted in advance from the management center computer 90 to Internet IN after the installation work has completed. Namely, the service engineer can make connection check speedily after the installation work has completed. Therefore, there is no need for the service engineer to work for a long time at a site to which they are dispatched for the purpose of connection check. In addition, there is no need for the service engineer to be dispatched many times for the purpose of connection check only. Further, E-mail address of the computer 90 and initial setting data or the like are automatically registered in the data terminal newly connected to the LAN 34. Thus, there is no need for the service engineer to input these items of data. Therefore, incorrect input of E-mail address of the computer 90 and initial setting data or the like to the data terminal newly connected to the LAN 34, can be prevented.

(Second Embodiment)

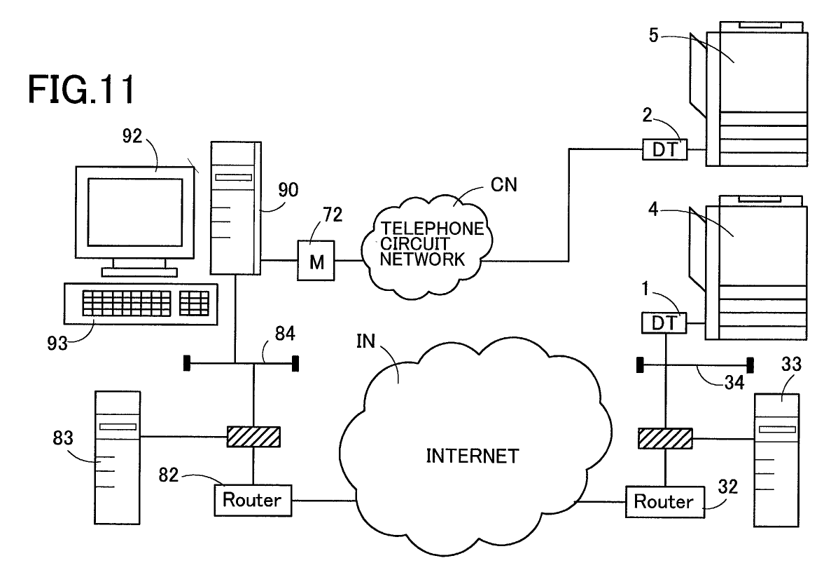

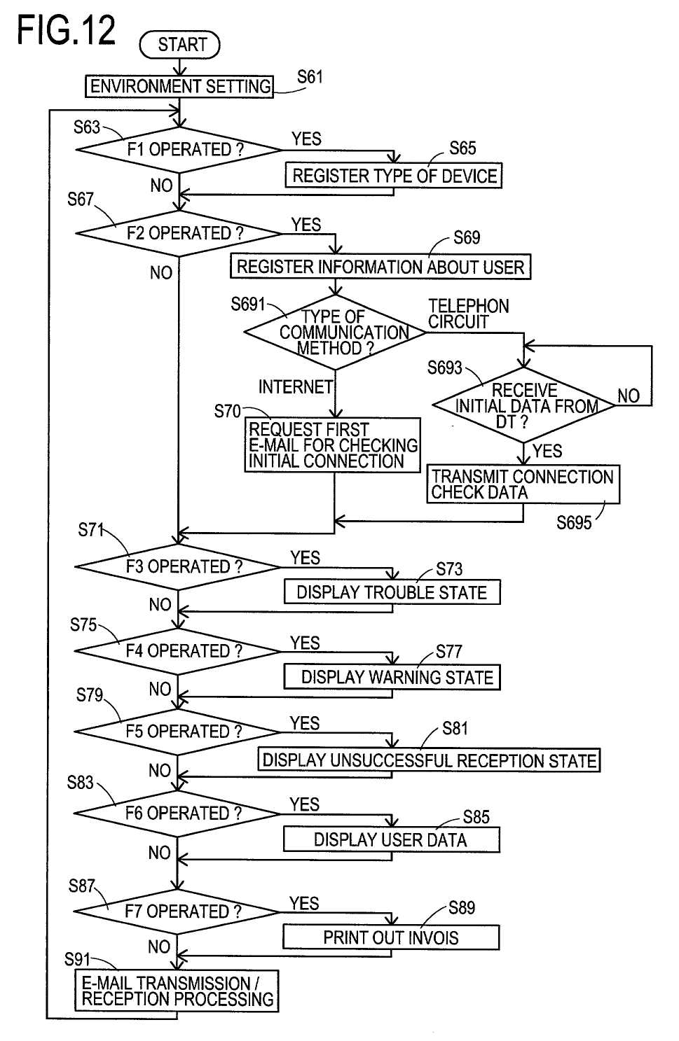

Now, a second embodiment of the present invention will be described with reference to FIG. 11 and FIG. 12. A management system according to the second embodiment is different from that according to the first embodiment in that another communication method such as public telephone circuit can be selected as a method of communication between a data terminal and a management center (computer 90) without being limited to non-real time communication (the first embodiment exemplifies packet data communication utilizing Internet), and that the computer 90 identifies type of communication method. Elements like ones in the first embodiment are designated by like reference numbers. A description of such elements is omitted here.

FIG. 11 is a view showing a configuration of a copying machine management system according to the second embodiment. This system is composed of: a copying machine 5 installed at the user site; a data terminal 2 (equipment management apparatus); a modem 72 connected to the computer 90 at the management center site; a telephone circuit network CN for connecting a modem incorporated in the data terminal 2 to a modem 72 at the management center site as well as constituent elements shown in FIG. 1.

That is, in the copying machine management system according to the second embodiment, as in the first embodiment, various types of data transmitted from the copying machine 5 (for example, data concerning use state of expendables or troubles and the like) are collected by the data terminal 2. Then, the data collected by the data terminal 2 is transmitted to the management center computer 90 via the telephone circuit network CN. In addition, the computer 90 also transmits an instructive command to the data terminal 2 connected to the copying machine 5 via the telephone circuit network CN. Based on such data transmitted and received between the data terminal 2 (copying machine 5) and the computer 90, the copying machine 5 under the control of the data terminal 2 is managed by the computer 90.

In the case where a new data terminal is connected, it is required to check that data is normally transmitted and received between the newly connected data terminal and the management center computer 90. In this system, the computer 90 or the newly connected data terminal transmits initial connection check data for the purpose of this transmission reception check. This transmission source differs depending on type of communication means.

FIG. 12 is a main flow chart of the CPU 91 in the management center computer 90. Processing done when the key F2 is selected differs from processing according to the first embodiment (FIG. 9). At S69, new registration of user master is performed for user name, address, telephone number, device type and/or name, device number and routine checkup time and date or the like by operation of the keyboard 93. Here, a communication method of the newly connected data terminal 2 is also registered.

When new registration of user master completes, the type of the registered communication method is determined (S691). If the above communication method is a communication method that uses packet data via Internet, as in the first embodiment, an E-mail transmission request is made for initial connection check (S70). In the case of a communication method using a telephone circuit, a system waits until it has received initial transmission data from the newly connected data terminal 2 (S693). The data terminal 2 sends initial transmission data to the computer 90 via the telephone circuit network CN when a new data terminal is connected. At the data terminal 2, service engineer sets initial setting mode, and operates a push switch 21, whereby initial transmission data is transmitted.

When the computer 90 receives the initial transmission data from the data terminal 2 (S693: YES), it transmits connection check data to the data terminal 2 by return (S695). The connection check data includes: a display command for displaying initial connection check on the control panel 40 of the copying machine 5; DTID; CTID; and initial setting data or the like. When the data terminal 2 receives connection check data, an initial setting check screen is displayed on the control panel 40 of the copying machine 5, indicating the fact that the data has been normally received. At this time, information on DTID, CTID and the like is also displayed. Through this display, the service engineer checks if initial connection has normally completed.

In this way, in the case where the computer 90 determines that communication means is in non-real time (such as Internet), as described in the first embodiment, the computer 90 transmits initial connection check data in advance to Internet IN. When the service engineer completes an installation work, the data terminal newly connected to the LAN 34 receives initial connection check data transmitted from the computer 90, the data being stored in the E-mail server 33. Then, the service engineer checks if the data terminal has successfully received initial connection check data on the control panel 40 of the copying machine, and terminates connection check.

On the other hand, in the case where the computer 90 determines that communication means is in real time (such as public telephone circuit or the like), the computer 90 is ready to receive initial transmission data from the newly connected data terminal. At this time, when a service engineer receives information from the management center by telephone or the like, the service engineer provides initial settings of the newly installed data terminal after connection work is completed. After doing this, the computer 90 transmits connection check data to the new data terminal by return in response to reception of initial transmission data. When the data terminal receives the connection check data transmitted by return, the fact is displayed on the control panel 40 of the newly installed copying machine. Then, the service engineer checks that initial connection has normally made by display of this control panel 40, and terminates connection check.

As has been described above in detail, the copying machine management system according to the second embodiment determines type of method of communication between a data terminal newly connected to the system and a management center computer 90. According to thus determined type, this system changes a method of originating connection check data for initial setting check. Therefore, a connection check method in conformance with type of communication means is employed so that service engineer can check speedily connection between the newly connected data terminal and the management center computer 90. In this manner, there is no need for the service engineer to work for a long time at a site to which they are dispatched for the purpose of connection check after an installation work has completed. In addition, there is no need for the service engineer to be dispatched many times for the purpose of connection check.

The above described embodiments are provided as mere examples, and do not mean that the present invention is limited. Of course, various modifications and/or variations can occur without departing from the gist of the invention. For example, in the above first embodiment, although packet data utilizing Internet has been exemplified as communication means, the present invention is applicable without being limited thereto as long as communication means is in non-real time. In addition, the present invention is also applicable to management of printers or the like as well as management of copying machines.

Additional advantages and modifications will readily occur to those skilled in the art. Therefore, the invention in its broader aspect is not limited to the specific details and representative embodiments shown and described herein. Accordingly, various modifications may be made without departing from the gist or scope of the general inventive concept as defined by the appended claims and their equivalents.

What is claimed is:

1. An equipment management system for managing equipment by an equipment management apparatus for acquiring management information from the equipment and a central management apparatus for centrally managing management information making packet data communication via a network over which a data processor is connected, the central management apparatus comprising:
a transmission controller for transmitting the data processor in advance packet data containing connection check data addressed to a newly installed equipment management apparatus,
the equipment management apparatus comprising:
a reception controller for acquiring the packet data containing the connection check data transmitted to the apparatus from the data processor before starting equipment management.

2. An equipment management system according to claim 1, wherein packet data containing the connection check data further comprises destination information on the equipment management apparatus, and the equipment management apparatus further comprises a memory for storing the destination information on the central management apparatus.

3. An equipment management system according to claim 1, wherein packet data containing the connection check data further comprises initial setting information on the equipment management apparatus, and the equipment management apparatus further comprises an initial setting controller for providing initial settings relevant to the apparatus itself based on the initial setting information.

4. An equipment management system according to claim 1, wherein the equipment management apparatus further comprises a display controller for displaying predetermined information on a display device in response to acquisition of the connection check data by the reception controller.

5. An equipment management system according to claim 4, wherein the display device is provided at an operating panel of equipment to be managed.

6. An equipment management system according to claim 1, wherein the central management apparatus further comprises an operating unit for registering information concerning an equipment management apparatus newly installed, and the transmission controller transmits the packet data containing the connection check data to the data processor in response to registration of information concerning the equipment management apparatus newly installed.

7. An equipment management system according to claim 1, wherein communication between the equipment management apparatus and the central management apparatus can be made by means of a second communication system that differs from a packet data communication system, and the transmission controller determines type of system of communication with an equipment management apparatus newly installed, and, in the case where the communication system is the second communication system, the controller waits for reception of initial transmission data transmitted from the equipment management apparatus newly installed, and transmits connection check data.

8. An equipment management system according to claim 7, wherein the second communication system is a communication system that utilizes a public telephone circuit network.

9. An equipment management system according to claim 1, wherein the network includes Internet.

10. An equipment management system according to claim 1, wherein equipment to be managed is an image forming apparatus for forming an image on a sheet.

11. An equipment management method for managing equipment by an equipment management apparatus for acquiring management information from equipment and a central management apparatus for centrally managing management information making packet data communication via a network over which a data processor is connected, the equipment management method comprising the steps of:
the central management apparatus transmitting to the data processor in advance, packet data containing connection check data addressed to an equipment management apparatus newly installed;
the equipment management apparatus acquiring from the data processor, packet data containing the connection check data transmitted to the apparatus itself before starting equipment management; and
starting equipment management, after the connection check data has been normally acquired by the equipment management apparatus.

12. An equipment management method according to claim 11, wherein the packet data containing the connection check data contains initial setting information on an equipment management apparatus newly installed, the equipment management method further comprising the step of providing initial settings relevant to the equipment management apparatus based on the initial setting information.

13. An equipment management method according to claim 11, further comprising the step of displaying predetermined information in a display device in response to acquisition of the connection check data by the equipment management apparatus.

14. An equipment management method for managing equipment by an equipment management apparatus for acquiring management information from equipment and a central management apparatus for centrally managing management information making communication in accordance with a first communication system or a second communication system, the equipment management method comprising the steps of:
registering information concerning an equipment management apparatus to be newly installed at the central management apparatus;
determining whether a communication system between the newly installed equipment management apparatus and the central management apparatus is a first communication system or a second communication system; and
in the case where the communication system is the first communication system, the central management apparatus transmitting connection check data addressed to the equipment management apparatus without receiving initial transmission data from the equipment management apparatus to be newly installed, and in the case where the communication system is the second communication system, the central management apparatus transmitting the connection check data addressed to the equipment management apparatus in response to reception of the initial transmission data from the equipment management apparatus to be newly installed.

15. An equipment management method according to claim 14, wherein the first communication system is a packet data communication system that utilizes Internet.

16. An equipment management method according to claim 15, wherein the second communication system is a communication system that utilizes a public telephone circuit network.
